(19) United States
(12) Patent Application Publication
(10) Pub. No.: US 2006/0099310 A1
(43) Pub. Date: May 11, 2006

(54) Personalized nutritional supplement

(76) Inventor: Ralph Koekkoek, Maastricht (NL)

Correspondence Address: MORRISON & FOERSTER LLP, 12531 HIGH BLUFF DRIVE, SUITE 100, SAN DIEGO, CA, 92130-2040, US

(21) Appl. No.: 10/985,257

(22) Filed: Nov. 10, 2004

(51) Int. Cl. A23L 3/36

(52) U.S. Cl. 426/331

(57) ABSTRACT

The disclosed invention relates to devices and methods for the automatic preparation of a personalized nutritional supplement in a retail outlet.

### TECHNICAL FIELD

The disclosed invention relates to devices and methods for the automatic preparation of nutritional supplements tailored to a subject's particular genotype, phenotype or personal preference. In a preferred embodiment, the disclosed invention relates to devices and methods for automatically preparing personalized nutritional supplements in a store or other retail center.

### BACKGROUND ART

The old saying, “You are what you eat,” shows that people have long been aware of the link between diet and health. As science's understanding of the human body evolves and matures, so does the understanding of how diet influences an individual's health. The science of nutrigenomics is putting this enhanced understanding of the human body to work to provide humanity with better diets.

After years of effort the International Human Genome Sequencing Consortium (IHGSC) and Celera Genomics, published maps of the human genome in the Feb. 15, 2001 issue of Nature and the Feb. 16, 2001 issue of Science, respectively. From these maps it has been estimated that there are approximately 30,000 genes in the human genome. Different people use different genes at times in their lives and different people carry different forms or variations of those genes. Some genes are active at different times in a person's lifecycle; some genes become active in response to particular stimuli. So, while individual human beings all carry the same or similar types of genes, particular individuals may possess different forms of genes or may use them in different way in response to a particular environment. The set of genes that are active at a particular point in time determines the phenotype of that person.

Nutrigenomics looks at a person's genotype, phenotype and environment to determine what nutrients are missing from a person's diet or should be increased in that diet to maximize health. Nutrigenomics makes sense when one considers that a person's diet will influence which genes are being used by that person at a given time. For example, the genes that control glucose metabolism, like insulin, will increase in activity when a person eats sugary foods. Thus, the study of nutrigenomics helps one to understand how a particular human body works and interacts with its environment.

The science of nutrigenomics has more than mere academic utility, however. In one application, nutrigenomics can be used to treat or prevent certain disease states. It is recognized that under certain conditions, some individuals run an increased chance of contracting a number of diseases because of their diet. By identifying individuals at risk and the dietary conditions that encourage disease, these diet-related diseases can be avoided or at least mitigated. Thus, using nutrigenomics, nutritional supplements can be designed to eliminate dietary conditions that can lead to disease, morbidity or mortality on an individual, person-by-person basis.

As this concept of personalized nutritional supplements gains popularity, the current practice of providing a “shotgun” or “one size fits all” approach to nutritional supplements will become antiquated. With the increased understanding of how genes influence health, customized dietary supplements will play an increasingly important part of people's diets. As this occurs, the traditional multivitamin approach and its inherent inefficiencies will become less commercially viable.

Presently, there are a number of companies that determine a person's nutritional needs on the basis of genotypic/phenotypic analysis. Examples of such companies include SCIONA (www.sciona.com), INTERLEUKIN (www.ILgenetics.com), GENELINK (www.bankdna.com), and GREAT SMOKIES DIAGNOSTICS (www.genovations.com). Other companies like ONE PERSON HEALTH (www.OnePersonHealth.com) or Market America (www.marketamerica.com) use these analysis to determine what nutritional supplements are appropriate to the individual and provide these supplements to them. The nutritional supplements provided by these companies are typically supplied to the individual by mail, in bulk and usually in the form of a plurality of pills and the like.

The disclosed invention improves upon this system by providing an automated device for formulating a personalized nutritional supplement. The automated device receives personal information and processes that information to provide a unitary dose of nutritional supplements. In a preferred embodiment, the formulation device prepares and provides for sale a unitary nutritional supplement for sale in a retail establishment.

### SUMMARY OF THE INVENTION

In a preferred embodiment, an automatic compounding device of the disclosed invention typically comprises an input device that receives information, a control device linked to the input device, and a compounding system, where the control device processes input information from the input device into formulation information, which is transmitted to the compounding system, which automatically compounds the unitary, personalized nutritional supplement. In various aspects of this embodiment, the input device can be a modem, such as a wireless modem, a keyboard, a card reader, or any other device that can recognize information and convey that information to the control device. Preferably, the device is located in a retail store or outlet.

Preferably, the information provided to the input device is selected from the group consisting of personal identification information, such as a person's name, home address, telephone number, a personal identification number, a finger print, a retinal pattern or other personally identifying information. In another aspect, the personal information provided relates to the results of a genotypic and/or phenotypic analysis, the answers to a questionnaire, a list of one or more nutritional or dietary needs, a list of one or more desired nutritional supplements, and a nutritional supplement recipe.

In another aspect, the control device is a device from processing personal identification information into compounding instructions. A computer that processes the personal information into compounding instructions would be a suitable control device. In practice, when the personal information provided by the input device is a genotypic/phenotypic analysis, the computer converts the analysis to compounding instructions. Alternatively, when the formulation information is a list of nutritional needs, the computer converts the list to compounding instructions. In another alternative aspect of this embodiment, the formulation information is a nutritional supplement recipe and the computer converts the recipe to compounding instructions.

Another preferred embodiment of the disclosed invention is a method of automatically compounding a unitary, personalized nutritional supplement, where the method comprises providing formulation information to a device that automatically compounds the unitary, personalized nutritional supplement. In one aspect of this embodiment, the formulation information is a nutritional supplement recipe and the control device is a computer that converts the recipe to compounding instructions. Alternatively, the formulation information is a list of nutritional needs and the control device is a computer that converts the list to compounding instructions. In another alternative aspect, the formulation information is a genotypic/phenotypic analysis and the control device is a computer that converts the analysis to compounding instructions. In another aspect of the disclosed invention, the formulation information is provided over a telephone line or via the internet.

### BRIEF DESCRIPTION OF THE DRAWINGS

FIG. 1 shows a block diagram illustrating an automatic personalized nutritional supplement preparation system.

FIG. 2 shows a flowchart of the disclosed formulation device.

FIG. 3 shows a block diagram of an exemplary compounding system.

### DETAILED DESCRIPTION OF THE PREFERRED EMBODIMENTS

The disclosed invention relates to devices and methods for the automatic preparation of a personalized nutritional supplement that is tailored to a subject's individual nutritional needs. The personalized nutritional supplements of the disclosed invention are based on the subject's individual nutritional needs and are preferably compounded and sold in a retail outlet. The subject's individual nutritional needs are determined based on the subject's genotype, phenotype, life style and/or personal preferences and desires.

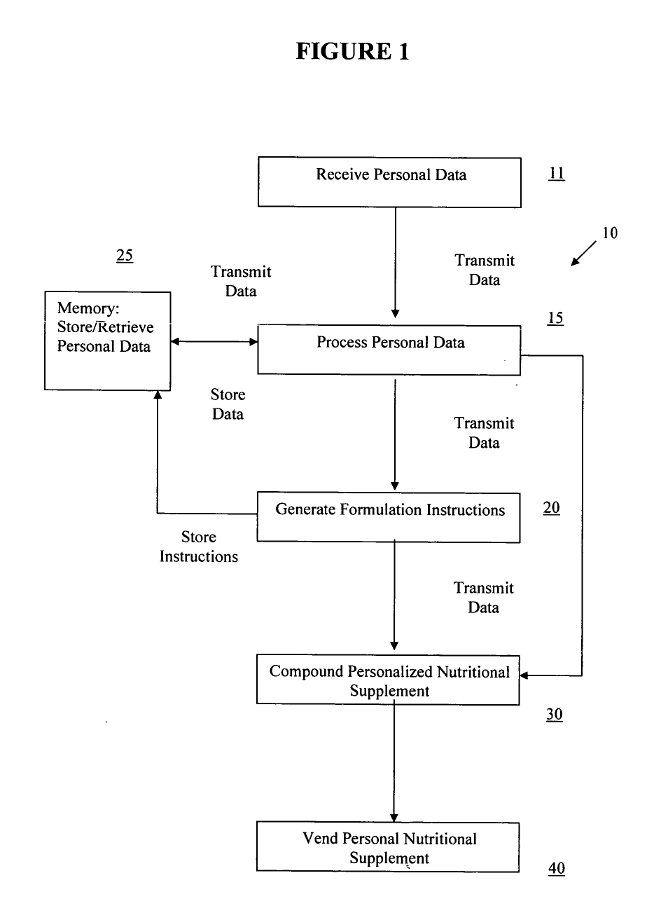

In practice, an individual provides personal data to an automatic compounding device of the disclosed invention. FIG. 1 is a block diagram illustrating a method for automatically compounding a personalized nutritional supplement for sale in a retail establishment. Referring to FIG. 1, an automatic compounding system 10 is shown. The compounding system performs a variety of functions. In a typical embodiment, the automatic compounding system 10 receives personal data from the subject 11. The personal data is transmitted for processing 15. The personal data is processed and used to generate formulation instructions 20. The processed personal data and the formulation instructions are stored in system memory 25 for future use. The formulation instructions are transmitted to a compounding system 30, which compounds and packages a personalized nutritional supplement based upon the personal data supplied by the subject. Once the compounding process is complete, the personalized nutritional supplement is vended to the subject 40.

The disclosed invention is contemplated for use in retail locations, such as a grocery store, health food store, athletic equipment store or the like. Placement of the disclosed device in retail locations provides distinct advantages over the methods presently used in the industry to supply nutritional supplements.

The disclosed device and methods of using it are superior to those presently used in part, because the disclosed invention increases the ease and speed with which individuals can acquire customized nutritional supplements. Placement of the disclosed devices in retail locations makes acquiring nutritional supplements more convenient, allows customers of the devices to spend their time more efficiently and minimizes time between purchasing and receiving of the supplements. Moreover, on-site formulation of personalized dietary supplements allows for users of the system to be assured that their nutritional supplements are made fresh and for their use alone.

The disclosed invention contemplates the automatic preparation of a personalized nutritional supplement. In a preferred embodiment, the components of the personalized nutritional supplement are combined into a discrete or unitary dose. The personalized nutritional supplements contemplated are “unitary” in that they are composed of a discrete combination of nutritional supplements that are formulated to meet that individual's particular nutritional needs. Advantageously, the personalized nutritional supplements consist of a single dose unit comprising all the individual's nutritional needs. The individual's nutritional needs are determined based upon their unique genotype and/or phenotype, including their diet and lifestyle.

Automatic Compounding Device

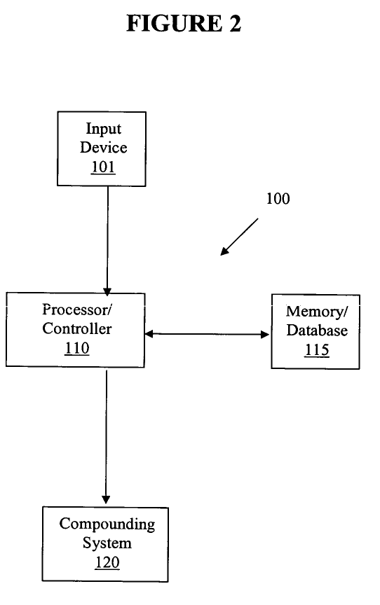

A block diagram describing the components of a preferred automatic compounding device 100 is shown in FIG. 2. The automatic compounding device comprises an input device 101, which is operably connected to a processor or controller 110, which in turn is operably connected to a memory/database unit 115 and a compounding system 120. Preferably, these components are housed within a discrete unit that can be placed in a store or other discrete retail location.

In operation, a subject provides personal data to the input device 101. The input device may optionally connected to a monitor or other display device. The personal data provided to the input device can be provided directly by the subject via a keyboard or other personal interface. Alternatively, the personal data can be provided remotely, for example via a modem, telephone line, internet, etc. In a preferred embodiment, the input device is a card reader that allows the user to supply an identification card, preferably a credit card, or some other type of card that carries stored information. The input device can access this stored information and use it to prepare a personalized nutritional supplement.

Other embodiments of the input device utilize any appropriate means of personal identification. Various biometric readers are available and can be used by the input device to identify a subject. For example, finger prints, retinal scans, and other biometric data can be used as personal data to identify a subject.

Once the personal data is entered via the input device 101, the processor/controller 110 processes the data and stores it in the memory/database unit 115. The processor/controller can he a programmable logic device (PLD), microcontroller, or computer, depending on the nature of the duties required by the processor/controller. The processor/controller can access the memory/database component of the system to run one or more appropriate programs or algorithms to translate the personal data provided into a recipe for a personalized nutritional supplement and directions for compounding a personalized nutritional supplement. The personal data provided and the programs or algorithms necessary to process that information into a personalized nutritional supplement are stored in the memory/database. The processor/controller and the memory/database are of the type one of ordinary skill in the art would consider appropriate for the intended functioning of the compounding system 120.

In one embodiment, the personal data provided to the input device 101 encompasses information relating to a person's genetic composition, expression patterns of a relevant subset of those genes that have been determined to link diet and disease, and details regarding the diet and lifestyle of the individual. In an alternative embodiment, the input device 101 is provided information regarding the nutritional needs of an individual, based on the genotype/phenotype of that individual. In yet another alternative embodiment, a particular personalized nutritional supplement recipe is provided to the input device. Preparation of a unitary, personalized nutritional supplement may be directed by entering any of these three types of data.

Depending on the type of data provided, the processor/controller 110 processes the data and compounds a personalized nutritional dietary supplement. In the case where an individual's genotypic/phenotypic data is provided to the input device 101, the processor/controller 110 processes the information to determine the nutritional needs of the individual. Based on those nutritional needs, the processor/controller 110 determines what personalized nutritional supplement recipe is required to meet the nutritional needs of the individual using the appropriate programs and algorithms stored in the memory/database 115.

Alternatively, when data is provided regarding the relevant personalized nutritional needs of an individual, the processor/controller 110 analyzes the data provided to determine what personalized nutritional supplement recipe is required to meet the nutritional needs of the individual. In another alternative, a nutritional supplement recipe is provided in the form of nutritional supplement ingredients and compounding specifications determined to meet the nutritional needs of the individual. Once the recipe for the personalized nutritional supplement is determined or provided, the processor/controller 110 directs compounding instructions to the compounding system 120 such that a personalized nutritional supplement is formulated.

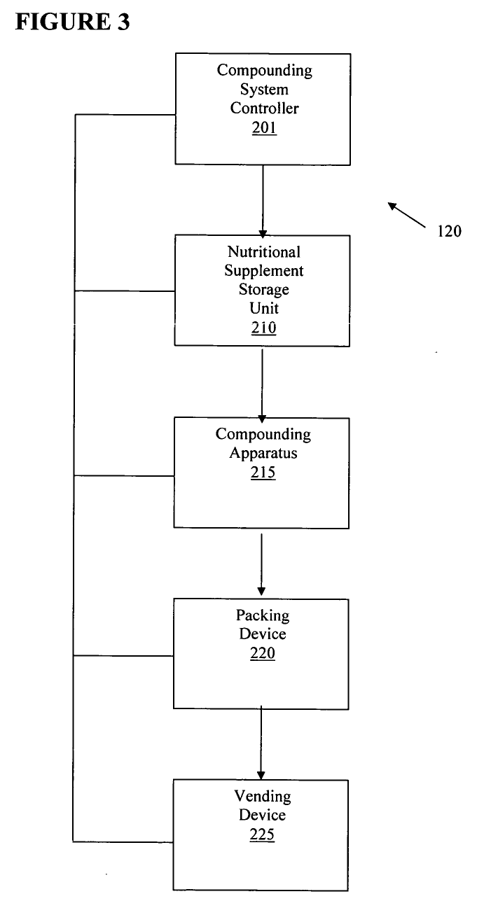

The compounding system typically comprises a plurality of nutritional supplements and mechanisms, such as valves, weigh stations, robotic components, and the like that compound the nutritional supplements. A block diagram of an exemplary compounding system 120 is shown in FIG. 3. In a preferred embodiment, the compounding system comprises a compounding system controller 201. The compounding system controller can be a programmable logic device (PLD), microcontroller, or computer, depending on the nature of the duties required by the controller. The compounding system controller can access the memory/database unit 115 of the system directly or through the processor/controller 110 to run one or more appropriate programs or algorithms to control the flow of supplements from the nutritional supplement storage unit 210 to the compounding apparatus 215 in accordance with the personal information supplied.

The nutritional supplement storage unit 210 houses the nutritional supplements that are used to compound the personalized nutritional supplements of the disclosed invention. The nutritional supplements can be liquids; solids; emulsions; suspensions or the like; they can also comprise dried or desiccated material that is dissolved or otherwise reconstituted prior to dispensing to the individual. Discrete containers are used to hold each of the nutritional supplements. These containers are housed in the nutritional supplement storage unit 210 prior to use.

The compounding apparatus 215 will use any nutritional supplement that is generally accepted to meet a nutritional need. Examples of such nutritional supplements include vitamins, such as vitamin A, biotin, vitamins B1, B2, B3, B5, B6, B12, folate, 5-MTHF, vitamin C, vitamin D, vitamin E and vitamin K.

A variety of minerals can be used as nutritional supplements, including boron, calcium, chromium, chloride, copper, fluoride, iron, magnesium, manganese, molybdenum, potassium, phosphorus, sodium, selenium, vanadium, and zinc, including chemical complexes of these minerals. Other nutritionally active substances are used as nutritional supplements. These include so-called nutraceuticals such as alpha-lipoic acid, cruciferous vegetable concentrate, glycine, idebenone, indole-3-carbinol, L-carnitine, lutein, lycopene, L-serine, N-acetyl-L-cysteine, quercetin dehydrate, and taurine.

A variety of botanical compositions can be used as nutritional supplements. These compositions include andrographis extract, artichoke extract, banaba leaf extract, bilberry leaf extract, cat's claw bark extract, curcumin root extract, cinnamon root extract, dandelion root extract, epimedium grandiflorum extract, forskolin, garlic extract, ginko biloba leaf extract, goldenseal root extract, green tea leaf extract, hawthorne extract, rosemary extract, schizandra berry, scutellaria baicalensis, and silymarin.

The compounded personalized nutritional supplement can further comprise excipients, flavorings, colorings, sweeteners, and/or other ingredients to provide a pleasing, safe and effective nutritional supplement.

As directed by the processor/controller, the compounding system controller accesses and manipulates the various nutritional supplements contained within the compounding system to provide the desired personalized nutritional supplement. In one embodiment, the compounding apparatus 215 comprises a series of controlled valves, one or more robotic devices, as well as a plurality of stations from which the robot devices work, and a delivery station that delivers nutritional supplement product to the subject. The valves and robots employed by the system are capable of performing mechanical functions including selection and retrieval of the necessary item or items and manipulation of retrieved items such that the desired product is prepared. The compounding system controller 201 provides bi-directional communication between the valves, robots, and peripheral devices of the compounding apparatus 215 to produce the personalized nutritional product. The operational status of the compounding system 120, such as status information relating to supplement availability and compounding apparatus functionality are relayed by the compounding system controller to the processor/controller to permit external diagnostics on the compounding system.

Upon completion, the compounded personalized nutritional supplement is then packaged by a packing device 220. The packaged product is then conveyed to a vending device 225, where the subject can obtain the product after appropriate payment has been received by the input device. In a preferred embodiment, those nutritional supplements that are identified as being required for an individual's health are gathered and formulated into a single dose or discrete number of mixed delivery vehicles, such as pills, tablets, sachets, liquids, and the like. This formulation process eliminates the need for the individual to ingest a large number of pills or tablets.

The formulation device can also store the personal information of the individual, allowing for subsequent doses of the personalized nutritional supplement to be compounded without have to re-enter the genotypic/phenotypic data, the nutritional needs, or the personalized nutritional supplement recipe.

Personalized Nutritional Information

Before the rise of agriculture, the diet of human beings was determined by what was available. Humans had to seek food wherever they could find it and the fine points of a “balanced diet” had yet to be conceived. In stark contrast to the past, most people in developed nations can eat what they want and not merely what is available. While this degree of freedom elevates the standard of living as a species, it also brings with it a set of hazards that other animals do not necessarily have to endure.

In view of the cornucopia of foodstuffs available to humans today, the question of diet has gone from what can be eaten just to survive to what should be eaten to live long, healthy and productive lives. To maximize the favorable influences of a person's diet, it is important to identify the nutritional requirements that a particular person has. An individual's nutritional requirements are determined by the environment, the individual's genetic composition and the individual's phenotype. A person's nutritional requirements can also be based on a desire to change their physical appearance, such as to loose weight, gain weight, or gain muscle mass.

Looking at these factors, a person's diet may cause them to suffer from deficiency or an overabundance of certain compounds and compositions that may result in toxic effects in that person. Each of these states is encompassed by the term “nutritional requirement”. That is, a nutritional requirement results when a person's diet is either lacking in or contains an overabundance of a compound or factor that leads to a less than desirable phenotype.

Different people require different nutritional supplements at different times. The person wishing to reduce their overall weight or percentage of body fat will require one set of nutritional supplements. A person who engages in strenuous activity, such as exercise or demanding physical labor will require a different nutritional supplement. A person who is relatively inactive will need a different nutritional supplement. Changing levels of activity and changing personal desires for the physical form or phenotype, require different nutritional supplements. Thus, it may be necessary to analyze a person's genotype and phenotype at different times to determine more accurately what types of nutritional supplements should be provided, depending on the individual's environment.

Identification of Nutritional Needs

After genotypic and phenotypic analysis of the individual has been performed, the nutritional needs of the individual are identified. For example, individuals who are identified as not utilizing vitamin B efficiently are provided vitamin supplements and other nutritional supplements to increase the efficiency of vitamin B use. Nutritional supplements to prevent or reduce bone loss, cardiac disease, and insulin insensitivity, obesity, and other nutrition-linked disease states are formulated based on the genotypic and phenotypic analysis.

Genotypic and Phenotypic Evaluation

There are a number of methods available to perform the types of genotypic and phenotypic analyzes that are necessary to determine the nutritional needs of an individual. Perhaps the most important and most straight forward is the performing of an assessment of the person's diet and levels of physical activity. For example, a simple questionnaire is constructed that determines what the individual typically eats and when it is consumed. Questions to determine vitamin intake, amounts of fruits and vegetables consumed, meats, minerals, carbohydrates (both complex and simple), fats consumed, and toxins such as alcohol and caffeine would all likely comprise the questionnaire.

Additionally, the person is queried about how much and the nature of any physical activity the person engages in over a given period of time. Further questions serve to determine the gross phenotypic features of the individual, such as gender, height, weight and the dimensions of particular body parts such as thighs, abdomen, arms, neck, and the like. Blood pressure measurements and heart rate information is also gathered.

Once a baseline of information gathered using relatively non-invasive techniques is established, molecular information is sought. For example, there are a number of genes that can be assayed that reflect an individual's health. Single nucleotide polymorphism (SNP) detection in those genes is used to identify genetic susceptibility to disease states and a dietary supplement is prepared to meet the genotypic and phenotypic factors that lead or contribute to disease.

Many assays are available to analyze a person's genotype and phenotype with respect to various disease states, like cardiovascular disease, for example. An individual undergoing genotypic and phenotypic analysis to determine whether and what kind of nutritional supplements are required is subjected to dietary analysis, lifestyle analysis (exercise frequency, tobacco and alcohol use), blood samples, urine samples, hair samples, x-rays, etc. The presence of polymorphisms in a number of genes has been linked to a number of disease states.

### EXAMPLES

The following examples are provided which exemplify aspects of the preferred embodiments of the present invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Homocysteine/Methionine Metabolism: Hyperhomocysteinemia

Homocysteine/methionine metabolism has been linked to a number of disease states. The polymorphisms in the enzymes involved in this metabolic cycle have an impact on an individual's homocysteine and methionine levels.

One enzyme in this metabolic pathway is 5,10-methylenetetrahydrofolate reductase (MTHFR). A number of mutations in the MTHFR gene have been identified. One particular variant in the MTHFR gene may increase the risk of cardiovascular disease. The variant, C677T, produces a form of MTHFR that has reduced activity at higher temperatures. Mutations in MTHFR typically disrupt or eliminate methylenetetrahydrofolate reductase enzyme activity. Methylenetetrahydrofolate reductase is required to convert homocysteine to methionine. In individuals who have certain allelic forms of MTHFR, homocysteine accumulates and methionine is depleted. Many studies have indicated supplementation with folate and other B vitamins lowers homocysteine levels in those with a defective MTHFR enzyme.

Another enzyme in the pathway is 5-methyltetrahydrofolate-homocysteine methyltransferase (MTR). The MTR gene encodes the enzyme methionine synthase. This enzyme converts homocysteine to methionine. For efficient activity, methionine synthase requires methylcobalamin and methionine synthase reductase (MTRR). Polymorphisms in these genes cause increases in homocysteine levels and depletion of methionine levels. Adequate folic acid intakes can normalize high homocysteine levels via increased remethylation of homocysteine to methionine via 5-methyltetrahydrofolate-homocysteine methyltransferase.

The CBS gene encodes the enzyme cystathionine beta-synthase. This enzyme participates in homocysteine metabolism. Cystathionine beta-synthase uses vitamin B6 to convert homocysteine and serine to cystathionine. Another enzyme then converts cystathionine to cysteine. Mutations in the CBS can lead to elevated levels of homocysteine in the blood as well as depleted levels of methionine. Pyridoxine therapy for individuals who are responsive to this compound or betaine for pyridoxine non-responsive individuals can be used to overcome errors in CBS function.

### Example 2

### Mutagens and Toxins

Glutathione S-transferases (GSTs) catalyze the conjugation of glutathione to numerous potentially mutagenic or otherwise toxic compounds, including aliphatic aromatic heterocyclic radicals, epoxides, and arene oxides. For example, the enzymes detoxify carcinogenic polycyclic aromatic hydrocarbons and conjugate isothiocyanates. The GST family includes glutathione S-transferase-mu (GSTM1), glutathione S-transferase-theta (GSTT1), and glutathione S-transferase-pi (GSTP1). These variants of GST can cause an increase in mutagenic compounds within an individual. Glutathione ingestion is not particularly efficient to increase circulating glutathione levels in a subject. However, consumption of N-acetyl-cysteine (NAC), milk thistle, alpha lipoic acid, alpha-lactalbumin, turmeric, balloon flower root, and selenium can all assist in elevating glutathione levels.

The genes of the superoxide dismutase (SOD) family produce enzymes that remove reactive superoxide radicals (supercharged oxygen molecules) from cells by converting them to a less reactive form. Superoxide radicals are byproducts of normal cell processes and can damage cells if their levels are not controlled. Ingestion of antioxidants such as vitamins A, C, E, zinc, copper, selenium, coenzyme Q10, superoxide dismutase, and alpha-lipoic acid can all help to overcome low functioning SOD variants.

### Example 3

### Inflammation

Elevated levels of particular cytokines, such as interleukin-6 (IL-6) and tumor necrosis factor-alpha (TNF-α) are markers of inflammation. Elevated levels of IL-6 are associated with inflammation, and serve to facilitate the development of type 2 diabetes mellitus in obese individuals. At least one polymorphism in the IL-6 promoter has been shown to lead increased levels of IL-6. Tumor necrosis factor alpha (TNF-alpha) mediates inflammation. Polymorphisms in the TNF-alpha gene influence TNF-alpha production. Fish oil has been reported to suppress cytokine production and to have a variety of anti-inflammatory effects.

### Example 4

### Fatty Acid Metabolism

A number of genes and polymorphisms associated with those genes are thought to be associated with a variety of disease states, including cardiovascular disease. Apolipoprotein C-III (APOC3) gene polymorphisms modulate the effect of saturated fat (SAT) intake on plasma lipoproteins and LDL size. Similarly, SNPs in cholesteryl ester transfer protein (CETP) and lipoprotein lipase (LPL) are also associated with various disease states. Ingestion of L-carnitine can assist in lowering hyperlipidemic states.

### Example 5

### eNOS: Endothelial Nitric Oxide Synthase (NOS3)

Nitric oxide (NO) is known to lower blood pressure and improve blood flow. An endothelial nitric oxide synthase (eNOS) gene polymorphism (Glu298Asp) has been associated with cardiovascular disease. Ingestion of alpha-lipoic acid can increase eNOS activity.

### Example 6

### Insulin Sensitivity

Angiotensin I converting enzyme (ACE) converts angiotensin I to angiotensin II. A known polymorphism of the ACE gene has been reported as relating to insulin sensitivity in obese individuals. Angiotensin converting enzyme (ACE) is also expressed in the central nervous system (CNS), where its primary function comprises degradation of neuropeptides including substance P (SP). An antidepressant function for the enzyme has also been postulated.

Peroxisome proliferator-activated receptor gamma (PPAR-γ) is a member of a family of nuclear hormone receptors involved in the regulation of energy metabolism genes. PPAR-γ has been linked to a number of disease states including diabetes, obesity and cancer.

Chromium and vanadium can help improve insulin sensitivity.

### Example 7

### Bone Health

The vitamin D receptor (VDR) affects calcium and vitamin D uptake. Both calcium and vitamin D play pivotal roles in bone development. Polymorphisms in the VDR gene have been identified that impact calcium and vitamin D uptake. Collagen type 1 alpha gene (COL1A1) plays an important role in the production type 1 collagen, an important bone protein. Certain mutations in the COL1AI induce ostogenesis imperfecta, or extremely severe osteoporosis. A polymorphism in this gene, Sp1, has been reported as being associated with low bone mass and higher risk of fracture. Ingestion of vitamin D and calcium supplements can assist in engendering good bone health.

### Example 8

### Nutritional Supplement Formulation

A person undergoes genotypic/phenotypic testing and receives an evaluation and a recommendation for a nutritional supplement. The person takes this information to a formulation device disclosed herein, which is located in their neighborhood supermarket or health food supplier. The data generated regarding their genotypic/phenotypic testing is used by the formulation device to prepare a nutritional supplement specifically formulated to the person's nutritional needs.

### Example 9

### Remote Nutritional Supplement Formulation

The data generated for the person described in Example 8 is transmitted to the formulation device via a telephone line or the internet. The device then prepares the nutritional supplement. The individual is notified when the formulation process is complete and proceeds to the formulation device to pay for and retrieve the nutritional supplement.

### Example 10

### Mail Order Remote Nutritional Supplement Formulation

The data generated for the person described in Example 8 is transmitted to the formulation device via a telephone line or the internet. The device then prepares the personalized nutritional supplement, which is then mailed to the subject in exchange for payment or an agreement to pay.

### Example 11

### MTHFR SNP and a Personalized Nutritional Supplement as a Dietary Compensator

A subject provides dietary and lifestyle information. Information is provided regarding the subject's intake of various nutrients, include folate. The subject also provides a blood sample, which is tested using the polymerase chain reaction to determine the presence of any single nucleotide polymorphisms in the 5,10-methylenetetrahydrofolate reductase gene (MTHFR).

A SNP is found in the MTHFR gene which results in the C677T form of the enzyme to be expressed in the subject. Thus, the subject is considered to have a deficiency in MTHFR enzymatic activity. Methylenetetrahydrofolate reductase is required to convert homocysteine to methionine. In individuals who have certain allelic forms of MTHFR, homocysteine accumulates and methionine is depleted. This information is transmitted to a formulation device, which compounds a nutritional supplement comprising 450 μg folic acid and 50 μg vitamin B12 in a single capsule.

### Example 12

### MTHFR SNP and a Personalized Nutritional Supplement as a Dietary Compensator

A subject provides dietary and lifestyle information. Information is provided regarding the subject's intake of various nutrients, include folate. The subject also provides a blood sample, which is tested using the polymerase chain reaction to determine the presence of any single nucleotide polymorphisms in the 5,10-methylenetetrahydrofolate reductase gene (MTHFR).

### Example 13

### Personalized Nutritional Supplement Based on a Genetic Analysis

A DNA sample was provided and analyzed with respect to a subset of genes in which certain genetic variations are thought to affect a person's nutritional needs. The genes are concerned with cardiovascular health, vitamin B usage, detoxification of toxins, including the neutralization of oxidants, bone health, glucose usage and ability to process sources of inflammation. Genes analyzed are discussed in the proceeding examples.

Variations were found in MTHFR, MTR, CBS, GSTT1, IL-6, CETP, LPL, eNOS, ACE, VDR, COL1A1 and TNF-alpha. A nutritional supplement was designed to maximize the health of the individual who provided the DNA sample. The personalized formula was designed to strengthen specific areas of nutritional intake that are in need of support based on the genetic makeup of the individual.

The following table provides the suggested list of supplements that are automatically compounded into a nutritional supplement personalized to the nutritional needs of the individual who submitted the DNA sample.

TABLE I

| Supplement | Amount per personalized dose | |
|---|---|---|
| Vitamin A | 10,000 | IU |
| Vitamin B₆ | 50 | mg |
| Vitamin B₁₂ | 150 | μg |
| Thiamin | 10 | mg |
| Riboflavin | 40 | mg |
| Folate | 1500 | μg |
| Niacin | 125 | mg |
| Biotin | 400 | μg |
| Vitamin C | 250 | mg |
| Vitamin D₃ | 500 | IU |
| Vitamin E | 100 | IU |
| Pantothenic acid | 50 | mg |
| Calcium | 150 | mg |
| Iron | 10 | mg |
| Iodine | 150 | μg |
| Magnesium | 100 | mg |
| Zinc | 230 | mg |
| Selenium | 175 | μg |
| Copper | 5 | mg |
| Manganese | 5 | mg |
| Chromium | 350 | μg |
| Molybdenum | 75 | μg |
| Potassium | 100 | mg |

### Example 14

### Automatic Formulation of a Personalized Nutritional Supplement in a Retail Store

The personal data from Example 13 regarding the subject's genetic make up is transmitted to the automatic compounding device. The information is transmitted via the Internet to the automatic compounding device, which is located in a grocery store.

The personal data is received from the Internet by the input device. The personal information is transmitted to the processor/controller of automatic compounding device, which processes the data into compounding instructions such that a personalized nutritional supplement comprising the ingredients of Table 1 is ordered prepared. The compounding instructions and the personal data are stored in the memory/database of the automatic compounding device.

The compounding instructions are provided to the compounding system controller, which notes the ingredients outlined in Table 1. The compounding system controller instructs the nutritional supplement storage unit to provide the required ingredients to the compounding apparatus, which compounds a unitary personalized nutritional supplement. Once compounded, the personalized nutritional supplement is packed by the packaging device and provided to the vending device.

The vending device informs the compounding system controller that that the requested personalized nutritional supplement is prepared. The compounding system informs the processor/controller, which in turn sends an electronic message out through the input device to the source of the original personal data. The message instructs the requestor that the nutritional supplement is prepared. The subject, having received the electronic message journeys to his local grocery store, the address of which was selected by the subject when the order was originally placed. Upon arrival, the subject enters the store, goes to the compounding apparatus, and provides a credit card to the input device. The input device receives the card information, which is transmitted to the processor/controller, which sends a message to the subject's bank charging the card's account a predetermined sum for the nutritional supplement. Upon receipt of confirmation of payment, the automatically compounded personalized nutritional supplement is released to the subject for his individual use.

1. An apparatus adapted to automatically compound a personalized nutritional supplement for sale in a retail establishment, comprising:
an input device;
a control device linked to the input device; and
an automatic compounding system linked to the control device, wherein the input device accepts information and transmits the information to the control device, which processes the information into formulation instructions and transmit the formulation instructions to the automatic compounding system, which automatically compounds the personalized nutritional supplement.

2. The apparatus of claim 1, wherein the input device is a modem.

3. The apparatus of claim 2, wherein the input device is a wireless modem.

4. The apparatus of claim 1, wherein the input device is a keyboard.

5. The apparatus of claim 1, wherein the formulation information is selected from the group consisting of a genotypic and/or phenotypic analysis, a list of one or more nutritional needs, and a nutritional supplement recipe.

6. The apparatus of claim 1, wherein the control device is a computer that processes the formulation information to compounding instructions.

7. The apparatus of claim 6, wherein the formulation information is a genotypic/phenotypic analysis and the computer converts the analysis to compounding instructions.

8. The apparatus of claim 6, wherein the formulation information is a list of nutritional needs and the computer converts the list to compounding instructions.

9. The apparatus of claim 6, wherein the formulation information is a nutritional supplement recipe and the computer converts the recipe to compounding instructions.

10. A method of automatically compounding a personalized nutritional supplement in a retail outlet, comprising:
providing formulation information to the apparatus of claim 1;
automatically compounding the personalized nutritional supplement; and
dispensing the personalized supplement.

11. The method of claim 10, wherein the formulation information is a nutritional supplement recipe and wherein the control device is a computer that converts the recipe to compounding instructions.

12. The method of claim 10, wherein the formulation information is a list of nutritional needs and wherein the control device is a computer that converts the list to compounding instructions.

13. The method of claim 10, wherein the formulation information is a genotypic/phenotypic analysis and wherein the control device is a computer that converts the analysis to compounding instructions.

14. The method of claim 10, wherein the formulation information is provided over a telephone line.

15. The method of claim 10, wherein the formulation information is provided via internet.

16. The method of claim 10, wherein the retail outlet is a grocery store, health food store, or athletic equipment store.

17. A method of vending a personalized nutritional supplement, comprising:
providing personalized information for a subject to an input device;
determining formulation instructions from the personalized information; and
formulating the personalized nutritional supplement according to the formulation instructions;
the method producing, in use, the personalized nutritional supplement.

18. The method of claim 17, wherein the input device is linked to a control device.

19. The method of claim 18, wherein the control device is linked to an apparatus adapted to an automatic compounding system, wherein the input device accepts information and transmits the information to the control device, which processes the information into formulation instructions and transmit the formulation instructions to the automatic compounding system, which automatically compounds the personalized nutritional supplement.

20. The method of claim 19, wherein the input device is a modem.

21. The method of claim 20, wherein the input device is a wireless modem.

22. The method of claim 19, wherein the input device is a keyboard.

23. The method of claim 19, wherein the personalized information is selected from the group consisting of a genotypic and/or phenotypic analysis, a list of one or more nutritional needs, and a nutritional supplement recipe.

24. The method of claim 19, wherein the control device is a computer that processes the personalized information to compounding instructions.

25. The method of claim 24, wherein the personalized information is a genotypic/phenotypic analysis and the computer converts the analysis to compounding instructions.

26. The method of claim 24, wherein the formulation information is a list of nutritional needs and the computer converts the list to compounding instructions.

27. The method of claim 24, wherein the formulation information is a nutritional supplement recipe and the computer converts the recipe to compounding instructions.
